(19) United States
(12) Patent Application Publication
(10) Pub. No.: US 2022/0396687 A1
(43) Pub. Date: Dec. 15, 2022

(54) RUBBER COMPOSITION COMPRISING A SUITABLE FILLER AND A SUITABLE CROSSLINKING SYSTEM

(71) Applicant: COMPAGNIE GENERALE DES ETABLISSEMENTS MICHELIN, Clermont-Ferrand (FR)

(72) Inventor: ALINE RIOU, Clermont-Ferrand (FR)

(21) Appl. No.: 17/774,330

(22) PCT Filed: Nov. 4, 2020
(86) PCT No.: PCT/FR2020/051990

§ 371 Date: May 4, 2022

(30) Foreign Application Priority Data
Nov. 6, 2019 (FR) 1912466

(51) Int. Cl. C08L 9/00; B60C 1/00

(52) U.S. Cl. CPC C08L 9/00; B60C 1/0025; B60C 2001/0033

(57) ABSTRACT

A rubber composition is based on an elastomeric matrix comprising from 40 to 80 phr of at least one butadiene elastomer, a vulcanization system comprising sulfur and a vulcanization accelerator, in which the weight ratio of sulfur to vulcanization accelerator is strictly less than 1, and at least 55 phr of organic filler mainly comprising a carbon black, called black G, having a BET specific surface area ranging from 15 to 50 m²/g and a compressed oil absorption number (COAN) in a range of from 40 to 100 ml/100 g.

### TECHNICAL FIELD OF THE INVENTION

The invention relates to a rubber composition and to a run-flat tyre.

### PRIOR ART

For several years, tyre producers have sought to eliminate the need for the presence of a spare wheel on board the vehicle while guaranteeing the possibility of continuing on its way despite a significant or total loss of pressure in one or more tyres in order, for example, to go to a breakdown point without having to stop, in often hazardous circumstances, to fit the spare wheel.

When the inflation pressure is significantly reduced in comparison with the service pressure, or is even zero (this is then referred to as “run-flat” mode), the tyre must make it possible to cover a given distance at a given speed, for example 80 km at 80 km/h. This performance, referred to as “EM” (extended mobility) performance, is required by legislation or by motor vehicle manufacturers in order to allow the producer to present the tyre as being a run-flat tyre.

When the inflation pressure is close to the service pressure (this is then referred to as “normal running” mode), it is desirable for the tyre to exhibit performance, referred to as “IRM” (inflated running mode) performance, that is as high as possible. This IRM running performance includes, amongst other things, the weight, the rolling resistance or even the comfort.

One envisaged solution is the use of run-flat tyres which are provided with self-supporting sidewalls, sometimes referred to by their trade designations “ZP” for “zero pressure” or “SST” for “self-supporting tyre”, or “run-flat” for running while flat.

A run-flat tyre comprising a crown comprising a crown reinforcement, which reinforcement is formed of two crown plies of reinforcing elements and surmounted by a tread, is known from the prior art. Two sidewalls extend the crown radially inwards. The tyre also comprises two beads, each comprising a bead wire and also a carcass reinforcement anchored to each of the beads and extending from the beads through the sidewalls towards the crown. The sidewalls are reinforced by rubber sidewall reinforcers that are able to support a load at reduced pressure or even with no pressure. Each rubber sidewall reinforcer is made from a crosslinkable rubber composition and must exhibit certain properties in the cured state, in particular sufficient stiffness, in order to at least partially withstand the load at reduced pressure, or even without pressure.

Document WO 2014/105811 discloses a run-flat tyre comprising sidewall inserts in which the composition is based on functional polybutadiene and a blend of a carbon black having a BET specific surface area of between 15 and 25 m²/g and a COAN of between 65 and 85 ml/100g and of a carbon black having a BET specific surface area of between 0 and 11 m²/g, these sidewalls exhibiting high stiffness and low hysteretic loss. The composition is crosslinked with a “conventional” vulcanization system in which the weight ratio of sulfur to vulcanization accelerator is greater than 1.

Document FR 3 005 471 discloses a composition comprising, as predominant elastomer, a non-functional polybutadiene exhibiting a Mooney plasticity within a range of values extending from 40 to 70 Mooney units and a specific reinforcing filler, namely a carbon black exhibiting a BET specific surface area of between 15 and 25 m²/g and an oil absorption number of compressed samples (COAN) of between 65 and 85 ml/100 g. This composition is used in the inserts of sidewalls of a run-flat tyre and improves their resistance to heating.

Document EP 2 377 693 describes a run-flat tyre comprising a composition based on a blend of natural rubber and polybutadiene and at most 50 phr of filler, crosslinked by a conventional vulcanization system. The tyre has improved rolling resistance and good driving comfort.

The applicant has discovered a composition which makes it possible to obtain sidewall inserts for a run-flat tyre, having improved stiffness while at the same time further lowering the rolling resistance of the tyre comprising this reinforcer, by virtue of the combination of specific contents of elastomer and filler, and also a suitable vulcanization system. In particular, the applicant has discovered compositions exhibiting excellent stiffness at low deformations, while at the same time preserving, or even improving, the other characteristics.

### DETAILED DESCRIPTION OF THE INVENTION

A subject of the invention is at least one of the following embodiments:
1. Rubber composition based on:
   an elastomeric matrix comprising from 40 to 80 phr of at least one butadiene elastomer;
   a vulcanization system comprising sulfur and a vulcanization accelerator, in which the weight ratio of sulfur to vulcanization accelerator is strictly less than 1;
   at least 55 phr of organic filler mainly comprising a carbon black, called black G, having a BET specific surface area ranging from 15 to 50 m²/g and a compressed oil absorption number (CORN) ranging from 40 to 100 ml/100 g.
2. Composition according to the preceding embodiment, in which the butadiene elastomer is selected from the group consisting of polybutadienes, butadiene copolymers and mixtures thereof.
3. Composition according to the preceding embodiment, in which the butadiene copolymers are selected from the group consisting of butadiene/styrene copolymers and mixtures thereof.
4. Composition according to either of embodiments 1 and 2, in which the butadiene elastomer is selected from the group consisting of polybutadienes and mixtures thereof.
5. Composition according to any one of the preceding embodiments, in which the butadiene elastomer has a Mooney plasticity of between 40 and 75 MU and a glass transition temperature of between −108 and −80° C.
6. Composition according to any one of the preceding embodiments, in which the elastomeric matrix also comprises an isoprene elastomer, preferably selected from the group consisting of synthetic polyisoprenes, natural rubber, isoprene copolymers and mixtures of these elastomers.
7. Composition according to any one of the preceding embodiments, in which the butadiene elastomer is functionalized.
8. Composition according to the preceding embodiment, in which the functionalized butadiene elastomer comprises a functional group comprising a function selected from the group consisting of alkoxysilane, silanol, amine, carboxylic acid and polyether functions, and combinations thereof, preferably consisting of alkoxysilane, silanol and amine functions, and combinations thereof.
9. Composition according to the preceding embodiment, in which the functionalized butadiene elastomer comprises a functional group comprising at least one amine function.
10. Composition according to any one of embodiments 7 to 9, in which the functionalized butadiene elastomer is coupled and/or star-shaped.
11. Composition according to any one of the preceding embodiments, comprising from 20 to 60 phr of isoprene elastomer.
12. Composition according to any one of the preceding embodiments,comprising from 40 to 70 phr of butadiene elastomer and from 30 to 60 phr of isoprene elastomer.
13. Composition according to any one of the preceding embodiments, comprising from 55 to 80 phr, preferably from 55 to 75 phr, of carbon black G.
14. Composition according to any one of the preceding embodiments, not comprising carbon black of which the BET surface area is less than 15 m²/g or comprising less than 10 phr, preferably less than 5 phr, preferably less than 2 phr, preferentially less than 1 phr, thereof.
15. Composition according to any one of the preceding embodiments, comprising less than 10 phr, preferably less than 5 phr, preferably less than 2 phr and preferentially less than 1 phr of carbon black other than carbon black G.
16. Composition according to any one of the preceding embodiments, also comprising an inorganic filler selected from the group consisting of silica, alumina, chalk, clay, bentonite, talc, kaolin, glass microbeads, glass flakes, and mixtures thereof, preferably consisting of silica, chalk, clay, bentonite, talc, kaolin, and mixtures thereof.
17. Composition according to the preceding embodiment, comprising from 3 to 30 phr, preferably from 3 to 20 phr and very preferably from 3 to 15 phr of inorganic filler.
18. Composition according to any one of the preceding embodiments, in which the total of organic and inorganic filler is at most 110 phr, preferentially at most 80 phr and preferably at most 75 phr.
19. Composition according to any one of the preceding embodiments, in which the weight ratio of sulfur to vulcanization accelerator in the vulcanization system is less than or equal to 0.95, preferably less than or equal to 0.90, more preferentially less than or equal to 0.85 and preferably less than or equal to 0.80.
20. Finished or semi-finished rubber article comprising a composition according to any one of embodiments 1 to 19.
21. Tyre comprising a composition according to any one of embodiments 1 to 19.
22. Tyre according to the preceding embodiment, in which the rubber composition according to any one of embodiments 1 to 19 is present in at least one internal layer.
23. Tyre according to the preceding embodiment, in which the rubber composition according to any one of embodiments 1 to 19 is present in an internal layer selected from the group consisting of crown feet, decoupling layers, edge rubbers, padding rubbers, the tread underlayer, the sidewall reinforcer and combinations of these internal layers.
24. Run-flat tyre, characterized in that it comprises a sidewall reinforcer comprising a composition according to any one of embodiments 1 to 19.
25. Run-flat tyre according to the preceding embodiment, in which each bead comprises a side strip comprising a composition according to any one of embodiments 1 to 19.
26. Run-flat tyre according to either one of embodiments 24 and 25, in which each bead comprises a bead-wire filler comprising a composition according to any one of embodiments 1 to 19.

Definitions

The expression “part by weight per hundred parts by weight of elastomer” (or phr) should be understood as meaning, for the purposes of the present invention, the part by weight per hundred parts by weight of elastomer or of rubber, the two terms being synonyms.

In the present text, unless expressly indicated otherwise, all the percentages (%) indicated are weight percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b).

When reference is made to a “predominant” compound, this is understood to mean, for the purposes of the present invention, that this compound is predominant among the compounds of the same type in the composition, that is to say that it is that which represents the greatest amount by weight among the compounds of the same type. Thus, for example, a predominant polymer is the polymer representing the greatest weight with respect to the total weight of the polymers in the composition. In the same way, a “predominant” filler is that representing the greatest weight among the fillers of the composition. By way of example, in a system comprising just one polymer, the latter is predominant for the purposes of the present invention; and, in a system comprising two polymers, the predominant polymer represents more than half of the weight of the polymers. Preferably, the term “predominant” is understood to mean present at more than 50%, preferably more than 60%, 70%, 80%, 90%, and more preferentially the “predominant” compound represents 100%.

For the purposes of the present invention, the term “elastomeric matrix” is intended to mean all of the elastomers (or rubbers) of the rubber composition. Thus, the elastomeric matrix can in particular consist of a single elastomer but also of a blend of two or more elastomers.

The expression “composition based on” should be understood as meaning a composition including the mixture and/or the product of the in situ reaction of the various constituents used, some of these constituents being able to react and/or being intended to react with each other, at least partially, during the various phases of manufacture of the composition; the composition thus possibly being in the totally or partially crosslinked state or in the non-crosslinked state.

The transverse or axial direction of the tyre is parallel to the axis of rotation of the tyre.

The radial direction is a direction that intersects the axis of rotation of the tyre and is perpendicular thereto.

The axis of rotation of the tyre is the axis about which it turns in normal use.

A radial or meridian plane is a plane that contains the axis of rotation of the tyre.

The circumferential median plane, or equatorial plane, is a plane that is perpendicular to the axis of rotation of the tyre and divides the tyre into two halves.

The carbon-comprising compounds mentioned in the description can be of fossil or biobased origin. In the latter case, they can partially or completely result from biomass or be obtained from renewable starting materials resulting from biomass. Polymers, plasticizers, fillers, and the like, are concerned in particular.

The Mooney plasticity measurement is carried out according to the following principle and in accordance with Standard ASTM D-1646. The generally uncured polybutadiene is moulded in a cylindrical chamber heated at a given temperature, usually 100° C. After preheating for one minute, an L-type rotor rotates within the test specimen at 2 revolutions/minute and the working torque for maintaining this movement is measured after rotating for 4 minutes. The Mooney plasticity (ML 1+4) is expressed in “Mooney units” (MU, where 1 MU=0.83 newton.metre).

The glass transition temperature, Tg, is measured conventionally by differential scanning calorimetry (DSC), for example, and unless specifically indicated otherwise, according to Standard ISO 11357-2 of 2014.

Elastomers

The rubber composition according to the invention is based on from 40 to 80 phr of at least one butadiene elastomer. Thus, the composition according to the invention may contain one or more butadiene elastomers or a mixture of one or more butadiene elastomers with one or more other elastomers, for example diene elastomers other than butadiene elastomers.

The butadiene elastomer of the composition according to the invention is preferentially selected from the group consisting of polybutadienes (abbreviated to “BR”), butadiene copolymers and mixtures thereof. Such butadiene copolymers are more preferentially selected from the group consisting of butadiene/styrene (SBR) copolymers and mixtures thereof. Preferably, the butadiene elastomer is selected from the group consisting of polybutadienes and mixtures thereof. Preferably, the butadiene elastomer is non-syndiotactic.

Preferably, the butadiene elastomer is functionalized, that is to say it comprises at least one functional group. “Functional group” is understood to mean a group comprising at least one heteroatom selected from Si, N, S, O and P.

The functionalized butadiene elastomer preferably comprises a functional group comprising a function selected from the group consisting of alkoxysilane, silanol, amine, carboxylic acid and polyether functions, and combinations thereof, preferably comprising a function selected from the group consisting of alkoxysilane, silanol and amine functions, and combinations thereof, and very preferably a group comprising at least one amine function.

Preferably, the functionalized butadiene elastomer is coupled and/or star-shaped, for example by means of a silicon or tin atom which bonds the elastomer chains together.

Preferably, the functionalized butadiene elastomer is selected from the group consisting of functionalized polybutadienes and mixtures thereof. In a preferred case where the functionalized butadiene elastomer is selected from the group of functionalized polybutadienes, preferably coupled and/or star-shaped, it preferentially has a content of cis-1,4 units of at most 50% and preferably of at most 40% by weight of the total weight of the polybutadiene.

Such functionalized butadiene elastomers of use for the requirements of the invention are commercially available. Mention may be made, for example, of Nipol BR 1250H™, sold by Zeon Corporation.

The elastomeric matrix of the composition according to the invention also preferably comprises an isoprene elastomer.

“Isoprene elastomer” is understood to mean an isoprene homopolymer or copolymer, in other words a diene elastomer selected from the group consisting of natural rubber (NR), which may be plasticized or peptized, synthetic polyisoprenes (IRs), the various isoprene copolymers, in particular isoprene/styrene (SIRs), isoprene/butadiene (BIRs) or isoprene/butadiene/styrene (SBIRs) copolymers, and the mixtures of these elastomers.

Preferably, the isoprene elastomer is selected from the group consisting of synthetic polyisoprenes, natural rubber, isoprene copolymers and mixtures thereof, preferably from the group consisting of natural rubber, polyisoprenes comprising a weight ratio of cis-1,4 bonds of at least 90%, more preferentially of at least 98% relative to the weight of isoprene elastomer, and mixtures thereof. Preferably, the isoprene elastomer is natural rubber.

Preferably, the composition according to the invention comprises from 40 to 70 phr, preferentially from 45 to 70 phr, preferably from 50 to 70 phr of butadiene elastomer, which is preferentially functionalized. Preferably, the composition according to the invention comprises from 20 to 60 phr, preferentially from 30 to 60 phr, preferably from 30 to 55 phr, and very preferentially from 30 to 50 phr of isoprene elastomer.

Preferably, the composition according to the invention comprises from 50 to 70 phr of a butadiene elastomer selected from functionalized or non-functionalized polybutadienes, and from 30 to 50 phr of an isoprene elastomer selected from natural rubber and synthetic polyisoprenes, and very preferentially does not comprise any other elastomer.

The isoprene elastomer confers, among other things, green tack (“tack”) on the composition. Thus, the need to use a “tackifying” resin in the rubber composition, which might increase the hysteresis of the composition and thus negatively impact the rolling resistance of the tyre according to the invention, is limited, indeed even eliminated.

Filler

The rubber composition according to the invention is based on at least 55 phr of organic filler mainly comprising a carbon black, called black G, having a BET specific surface area ranging from 15 to 50 m²/g and a compressed oil absorption number (COAN) ranging from 40 to 100 ml/100 g.

The organic filler of the rubber composition according to the invention comprises carbon black, in the form of a single carbon black or of a blend of at least two carbon blacks.

Carbon blacks conventionally used in tyres (“tyre-grade” black) are suitable as carbon blacks. These carbon blacks can be used in the isolated state, as available commercially, or in any other form, for example as support for some of the rubber additives used. The carbon blacks might, for example, be already incorporated into an isoprene elastomer in the form of a masterbatch (see, for example, applications WO 97/36724 or WO 99/16600).

Carbon blacks are characterized by various properties, in particular by the BET specific surface area and by the oil absorption number of compressed samples (COAN for Compressed Oil Absorption Number). The COAN of carbon blacks is measured according to Standard ASTM D3493-16.

The BET specific surface area of carbon blacks is measured according to Standard D6556-10 (multipoint (a minimum of 5 points) method—gas: nitrogen—relative pressure p/p₀ range: 0.1 to 0.3).

Examples of carbon blacks G useful for the requirements of the invention are N683, N650, N660, N550, S204 sold by Orion Engineered Carbon, S820 sold by Omsk and BC1001 sold by Birla.

The organic filler comprises predominantly, that is to say at least 50% by weight, of black G. Preferably, the organic filler comprises 60%, 70%, 80%, 90% by weight of black G. Very preferably, the organic filler consists of black G.

The content of black G in the rubber composition according to the invention is preferentially within a range of values extending from 55 to 80 phr, preferably from 55 to 75 phr.

The rubber composition according to the invention preferably does not comprise carbon black, the BET surface area of which is less than 15 m²/g or comprises less than 10 phr, preferably less than 5 phr, preferably less than 2 phr, preferentially less than 1 phr, thereof.

The rubber composition according to the invention may also comprise an inorganic filler.

The physical state in which the inorganic filler is provided is not important, whether it is in the form of a powder, micropearls, granules, beads or any other appropriate densified form.

The inorganic filler is preferably selected from the group consisting of mineral fillers of the siliceous type, in particular silica (SiO₂), of the aluminous type, in particular alumina (Al₂O₃), chalk, clay, bentonite, talc, kaolin, glass microbeads, glass flakes, and a mixture thereof, preferably from silica, chalk, clay, bentonite, talc, kaolin and a mixture thereof, preferentially from silica, chalk, kaolin and a mixture thereof. Very preferably, the inorganic filler comprises silica.

The silica used may be any reinforcing silica known to those skilled in the art, notably any precipitated or fumed silica having a BET surface area and a CTAB specific surface area which are both less than 450 m²/g, preferably from 30 to 400 m²/g. As highly dispersible precipitated silicas (HDSs), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/16837.

In the present disclosure, the BET specific surface area of the silica is determined by gas adsorption using the Brunauer-Emmett-Teller method described in “The Journal of the American Chemical Society”, (vol. 60, page 309, February 1938), and more specifically according to a method derived from Standard NF ISO 5794-1, appendix E, of June 2010 [multipoint (5 point) volumetric method—gas: nitrogen—degassing under vacuum: one hour at 160° C.—relative pressure p/po range: 0.05 to 0.17].

The CTAB specific surface area of the silica is determined according to French Standard NF T 45-007 of November 1987 (method B).

In the preferred case where the inorganic filler comprises silica, the latter preferably has a BET surface area of between 45 and 400 m²/g, more preferentially of between 60 and 300 m²/g.

The composition according to the invention preferentially does not comprise an inorganic filler-elastomer coupling agent or comprises less than 5% by weight thereof relative to the weight of inorganic filler, preferably less than 2% by weight thereof, preferably less than 1% by weight thereof relative to the weight of inorganic filler.

The term “coupling agent” (or “binding agent”) is understood to mean, in a known manner, an agent capable of coupling the inorganic filler to the elastomer.

The chalk is preferentially in the form of microparticles, the mean size (by weight) of which is greater than 1 μm. The median size of the chalk microparticles, which is a measurement obtained on a sedigraph, is preferentially between 0.5 and 200 μm, more particularly between 0.5 and 30 μm and even more preferentially between 1 and 20 μm.

The chalks known to those skilled in the art are natural calcium carbonates (chalk) or synthetic calcium carbonates with or without coating (for example with stearic acid).

By way of examples of such preferential and commercially available chalks, mention may for example be made of the chalk sold under the name “Omya BLS” by Omya.

The rubber composition according to the invention preferentially comprises from 3 to 30 phr of inorganic filler, preferably from 3 to 20 phr and very preferably from 3 to 15 phr, preferentially from 3 to 10 phr and very preferentially from 3 to 7 phr.

Preferably, the total organic and inorganic filler in the composition according to the invention is at most 110 phr, preferentially at most 80 phr and preferably at most 75 phr.

Crosslinking System

The rubber composition according to the invention comprises a vulcanization system comprising sulfur and a vulcanization accelerator, in which the weight ratio of sulfur to vulcanization accelerator is strictly less than 1.

The crosslinking system is based on sulfur; it is then called a vulcanization system. The sulfur can be contributed in any form, in particular in the form of molecular sulfur or of a sulfur-donating agent. At least one vulcanization accelerator is also present, and, optionally, use may also be made of various known vulcanization activators, such as zinc oxide, stearic acid or equivalent compound, such as stearic acid salts, and salts of transition metals, guanidine derivatives (in particular diphenylguanidine), or else known vulcanization retarders.

The sulfur is used at a preferred content of between 1 and 10 phr, preferably between 3 and 7 phr. The vulcanization accelerator is used at a preferential content within a range extending from 3 to 12 phr, preferably extending from 3.1 to 10 phr.

Preferably, the weight ratio of sulfur to vulcanization accelerator in the vulcanization system is less than or equal to 0.95, preferably less than or equal to 0.90, more preferentially less than or equal to 0.85 and preferably less than or equal to 0.80.

The use of a vulcanization system in which the ratio of sulfur to vulcanization accelerator is strictly less than 1, in combination with the relatively high specific content of organic filler with regard to the prior art and of a blend of elastomers makes it possible to obtain a composition having, in the crosslinked state, improved stiffness both statically and dynamically, while at the same time maintaining acceptable hysteretic losses.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to “MBTS”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), tetrabenzylthiuram disulfide (“TBZTD”), zinc dibenzyldithiocarbamate (“ZBEC”) and the mixtures of these compounds.

Various Additives

The rubber composition according to the invention may also comprise all or some of the usual additives customarily used in elastomer compositions intended for the manufacture of tyres, such as, for example, plasticizers or extender oils, whether the latter are of aromatic or non-aromatic nature, pigments, protective agents, such as anti-ozone waxes, chemical anti-ozonants or antioxidants, anti-fatigue agents, reinforcing resins such as bismaleimides, methylene acceptors (for example, phenol-novolac resin) or methylene donors (for example, HMT or H3M).

Preferably, the rubber composition according to the invention does not comprise a reinforcing resin or comprises less than 10 phr, preferably less than 5 phr, preferably less than 2 phr, preferentially less than 1 phr and very preferably less than 0.2 phr thereof.

Reinforcing resin is understood to mean a resin known to those skilled in the art for stiffening rubber compositions. Thus, a rubber composition to which a reinforcing resin has been added will exhibit a higher stiffness, in particular a Young's modulus (measured in accordance with Standard ASTM 412-98a) or a complex dynamic shear G* (measured in accordance with Standard ASTM D 5992-96), than this composition without reinforcing resin. Such resins are, for example, phenolic resins, epoxy resins, benzoxazine resins, polyurethane resins, aminoplast resins, and the like.

Manufacture of the Compositions

The rubber composition according to the invention is manufactured in appropriate mixers using two successive preparation phases well known to those skilled in the art:
a first phase of thermomechanical working or kneading (“non-productive” phase), which can be carried out in a single thermomechanical step during which all the necessary constituents, in particular the elastomeric matrix, the fillers and the optional other various additives, with the exception of the crosslinking system, are introduced into an appropriate mixer, such as a standard internal mixer (for example of ‘Banbury’ type). The incorporation of the filler into the elastomer may be performed in one or more portions while thermomechanically kneading. In the case where the filler is already incorporated, in full or in part, in the elastomer in the form of a masterbatch, as is described, for example, in applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated.

The non-productive phase is carried out at high temperature, up to a maximum temperature of between 130° C. and 170° C., for a period of time generally of between 2 and 10 minutes.
a second phase of mechanical working (“productive” phase), which is carried out in an external mixer, such as an open mill, after cooling the mixture obtained during the first non-productive phase down to a lower temperature, typically of less than 110° C., for example between 40° C. and 100° C. The crosslinking system is then incorporated and the combined mixture is then mixed for a few minutes, for example between 1 and 30 min.

The final composition thus obtained is subsequently calendered, for example in the form of a sheet or of a plaque, in particular for a laboratory characterization, or also extruded in the form of a rubber semi-finished (or profiled) element which can be used, for example, as an internal layer in a tyre.

The composition may be either in the green state (before crosslinking or vulcanization) or in the cured state (after crosslinking or vulcanization), and may be a semi-finished product which can be used in a tyre.

The crosslinking of the composition can be carried out in a way known to those skilled in the art, for example at a temperature of between 130° C. and 200° C., preferably under pressure, for a sufficient time which can vary, for example, between 5 and 90 min.

Finished or Semifinished Rubber Articles

A subject of the present invention is also a finished or semi-finished rubber article, such as for example a conveyor belt, and also a tyre, comprising a composition according to the invention. The invention relates to the articles and tyres both in the raw state (that is to say, before curing) and in the cured state (that is to say, after crosslinking or vulcanization).

Tyre

The invention also relates to a tyre comprising a rubber composition according to the invention. The present invention relates in particular to tyres intended to equip motor vehicles of passenger vehicle type, SUVs (“Sport Utility Vehicles”), or two-wheel vehicles (in particular motorcycles), or aircraft, or also industrial vehicles selected from vans, heavy-duty vehicles—that is to say, underground trains, buses, heavy road transport vehicles (lorries, tractors, trailers) or off-road vehicles, such as heavy agricultural or construction vehicles—and others, and preferably to tyres intended to equip vehicles of heavy-duty type.

The tyre according to the invention comprises two beads intended to come into contact with a mounting rim, two sidewalls extending the beads radially outwards and coming together in a crown comprising a tread, at least one carcass reinforcement extending from the beads through the sidewalls as far as the crown, said reinforcement being anchored in the two beads, an airtight layer extending between the two beads and located axially inside the carcass reinforcement, each bead comprising at least:
an annular reinforcing structure known as a bead wire;
an internal layer extending radially outwards from said bead wire and in contact with said carcass reinforcement, known as bead-wire filler;
optionally an internal layer located axially outside the carcass reinforcement and the bead-wire filler, known as side strip.

The term “internal layer” is understood to mean a layer which is neither in contact with the ambient air nor with the inflation gas. In a known way, it is possible to define, within the tyre, three types of regions:
The radially exterior region in contact with the ambient air, this region essentially consisting of the tread and of the outer sidewall of the tyre.
The radially interior region in contact with the inflation gas, this region generally being composed of the layer airtight to the inflation gases, known as “airtight layer” and sometimes referred to as inner liner.
The internal region of the tyre, that is to say that between the exterior and interior regions. This region includes layers or plies which are referred to here as tyre internal layers. This type of layer can, for example, be a tread underlayer, a layer of the crown of the tyre, a carcass ply, a layer of the bead, or any other layer which is not in contact with the ambient air or the inflation gas of the tyre.

Preferably, the invention relates to a tyre in which the rubber composition according to the invention is present in at least one internal layer of said tyre.

Advantageously, said internal layer of said tyre is selected from the group consisting of the crown feet, decoupling layers, edge rubbers, padding rubbers, tread underlayer, the sidewall reinforcer and combinations of these internal layers. In the present text, the term “edge rubber” is understood to mean a layer positioned in the tyre directly in contact with the end of a reinforcing ply, with the end of a reinforcing element or with another edge rubber.

The invention preferentially relates to a run-flat tyre, characterized in that it comprises a sidewall reinforcer comprising a composition according to the invention.

Preferably, each bead of the run-flat tyre comprises a bead-wire filler comprising a composition according to the invention.

Preferably, each bead comprises a side strip comprising a composition according to the invention.

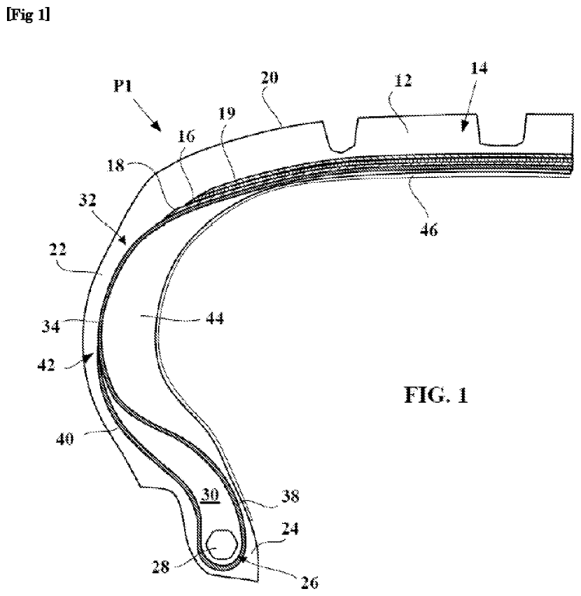

FIG. 1 schematically depicts, in radial cross-sectional view, a tyre according to one embodiment of the invention denoted by the general reference P1. The tyre P1 is of the run-flat type. The tyre P1 is intended for a passenger vehicle.

This tyre P1 comprises a crown 12 comprising a crown reinforcement 14, formed of two crown plies of reinforcing elements 16, 18 and of a hooping ply 19. The crown reinforcement 14 is surmounted by a tread 20. Here, the hooping ply 19 is positioned radially outside the plies 16, 18, between the plies 16, 18 and the tread 20. Two self-supporting sidewalls 22 extend the crown 12 radially inwards.

The tyre P1 additionally comprises two beads 24 radially on the inside of the sidewalls 22 and each comprising an annular reinforcing structure 26, in this instance a bead wire 28, from which extends radially outwards a weight of padding rubber 30 on the bead wire, and a radial carcass reinforcement 32.

The carcass reinforcement 32 extends from the beads 24 through the sidewalls 22 towards the crown 12. It comprises at least one carcass ply 34 comprising, as is well known to those skilled in the art, reinforcing elements parallel to each other extending in a plane substantially parallel to the axial direction of the tyre P1 (“radial” carcass reinforcement). In FIG. 1, the ply 34 is anchored to each of the beads 24 by a turn-up around the bead wire 28, so as to form, within each bead 24, a main strand 38 extending from the beads through the sidewalls towards the crown, and a turn-up strand 40, the radially outer end 42 of the turn-up strand 40 being substantially midway up the height of the tyre.

The rubber compositions used for the crown plies 16, 18 and carcass ply 34 are conventional compositions for the calendering of reinforcing elements, typically based on natural rubber, carbon black, a vulcanization system and the usual additives. When the reinforcing elements are textile reinforcing elements, in particular here in the carcass reinforcement, adhesion between the textile reinforcing element and the rubber composition that coats it is ensured for example by a standard adhesive of RFL type.

The tyre P1 also comprises two sidewall inserts 44, axially on the inside of the carcass reinforcement 32. These inserts 44 with their characteristic crescent-shaped radial section are intended to reinforce the sidewall. Each insert 44 is manufactured from a rubber composition based on a crosslinkable rubber composition according to the invention. Each sidewall insert 44 is capable of contributing to supporting a load corresponding to a portion of the weight of the vehicle during a run-flat situation.

The tyre also comprises an airtight inner layer 46, preferably made of butyl, located axially on the inside of the sidewalls 22 and radially on the inside of the crown reinforcement 14 and extending between the two beads 24. The sidewall inserts 44 are located axially on the outside of the inner layer 46. Thus, the sidewall inserts 44 are positioned axially between the carcass reinforcement 32 and the inner layer 46.

### EXAMPLE

Measurement Methods

Dynamic Properties

The dynamic properties G* (10%) and tan(δ)max at 40° C. are measured on a viscosity analyser (Metravib VA4000) according to Standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under the defined conditions of temperature, for example at 40° C., according to Standard ASTM D 1349-99 or, as the case may be, at a different temperature, is recorded. A strain amplitude sweep is carried out from 0.1% to 50% (outward cycle) and then from 50% to 0.1% (return cycle). The results made use of are the complex dynamic shear modulus G* and the loss factor tan(δ). The maximum value of tan(δ) observed, denoted tan(δ)max, and the complex dynamic shear modulus G* (10%) at 10% strain, at 40° C., are shown for the return cycle.

It is recalled that, in a manner well known to those skilled in the art, the value of tan(δ)max at 40° C. is representative of the hysteresis of the material and therefore of the rolling resistance: the lower the tan(δ)max at 40° C., the more reduced and therefore improved the rolling resistance is. Thus, a value lower than 100 will indicate reduced rolling resistance compared to the reference composition.

Static Properties

The tests were performed in accordance with the French Standard NF T 46-002 of September 1988. All the tensile measurements were performed under standard conditions of temperature (23±2° C.) and hygrometry (50%±5% relative humidity), according to French Standard NF T 40-101 (December 1979).

The nominal secant moduli calculated by referring back to the initial cross section of the test specimen, (or apparent stress, in MPa) was measured at 6% elongation, denoted MA6, on samples cured at 160° C. for 10 minutes.

The greatest possible static stiffness, without however degrading the rolling resistance, is sought for these compositions, particularly when they are used as a sidewall reinforcer or in a bead. A static stiffness of at least 6 MPa is considered to be particularly advantageous for obtaining a good stiffness/rolling resistance compromise.

Preparation of the Compositions

The tests which follow are carried out in the following way: the butadiene elastomer, the reinforcing filler and also the various other ingredients, with the exception of the vulcanization system, are successively introduced into an internal mixer (final degree of filling: approximately 70% by volume), the initial vessel temperature of which is approximately 70° C. Thermomechanical working (non-productive phase) is then carried out in one step, which lasts in total approximately from 3 to 4 min, until a maximum “dropping” temperature of 170° C. is reached.

The mixture thus obtained is recovered and cooled and then the vulcanization system is incorporated, everything being mixed (productive phase) for an appropriate time (for example between 5 and 12 min).

The compositions thus obtained are subsequently calendered, in the form of plaques (thickness of 2 to 3 mm) or of thin sheets of rubber, and are then subjected to a curing step at 160° C. for 10 min, before the measurement of their physical or mechanical properties “in the cured state”.

### Example 1

Tests were carried out with different rubber compositions presented in Table 1, based on a blend of natural rubber and of an elastomer consisting of non-functional polybutadiene.

The dynamic shear modulus G* and the MA6 elongation modulus, expressed in MPa, are then measured in the cured state, therefore after vulcanization.

G* is expressed in base 100, taking the composition C1 as reference. Thus, for the modulus G*, a value lower than 100 indicates a lower modulus and therefore a less stiff composition. The composition C1 corresponds to the composition M2 of document FR 3 005 471. In the composition C2, the amount of filler, of the vulcanization system and of additives was adjusted in order to best approach the target in terms of MA6, while at the same time maintaining the same sulfur/accelerator ratio as for the prior art composition C1.

TABLE 1

| | C1 | C2 | C3 | C4 |
|---|---|---|---|---|
| NR (1) | 35 | 35 | 35 | 35 |
| Non-functional BR (2) | 65 | 65 | 65 | 65 |
| Black S204 (3) | 50 | 65 | 50 | 65 |
| Additives (4) | 9 | 11 | 11 | 11 |
| Vulcanization system (5) | 6 | 7 | 9 | 9 |
| Of which insoluble sulfur | 3 | 4 | 4 | 4 |
| S/accelerator weight ratio | 1.2 | 1.2 | 0.8 | 0.8 |

Properties in the cured state - base 100 relative to C1

| | | | | |
|---|---|---|---|---|
| MA6 - modulus at 6% (23° C.) | 4.2 | 5.7 | 4.9 | 6.9 |
| (MPa) | | | | |
| G* 10% Deformation (40° C.) | 100 | 139 | 113 | 152 |

The amounts are indicated in phr (parts by weight per hundred parts of elastomers).
(1) Natural rubber
(2) Polybutadiene Buna CB24 sold by Lanxess, Mooney plasticity of 44 MU
(3) Carbon black S204 from Orion Engineered Carbon, S_{BET} = 19 m²/g, COAN = 76 ml/100 g.
(4) The additives comprise zinc oxide (industrial grade, Umicore company), stearic acid (“Pristerene 4931” from Uniqema), N-1,3-dimethylbutyl-N-phenylparaphenylenediamine (“Santoflex 6-PPD” from Flexsys) and polymer 2,2,4-trimethyl-1,2-dihydroquinoline (TMQ)
(5) The vulcanization system comprises the insoluble sulfur, the accelerator (N,N-dicyclohexylbenzothiazole-2-sulfenamide from Flexsys) and the vulcanization retarder (N-cyclohexylthiophthalimide sold under the name “Vulkalent G” by Lanxess)

It is observed that the combination of the filler content and the ratio of sulfur to accelerator makes it possible to improve both the static stiffness at low deformations and the dynamic shear modulus of the composition. It is noted that, for the composition C4 in accordance with the invention, the increase in the elongation modulus is greater than that which could have been expected by adding the effects of a reduction in the ratio of sulfur to accelerator and the filler content.

### Example 2

Additional tests were carried out with the various rubber compositions presented in Table 2, based on a blend of natural rubber and of an elastomer consisting of functional polybutadiene.

The dynamic shear modulus G* and the value of tan(δ)ₘₐₓ, expressed in base 100 taking the composition C5 as reference, and the MA6 elongation modulus expressed in Mpa, are then measured in the cured state, therefore after vulcanization.

TABLE 2

| | C5 | C6 | C7 | C8 | C9 | C10 |
|---|---|---|---|---|---|---|
| NR (1) | 35 | 35 | 65 | 35 | 35 | 35 |
| Functional BR (2) | 65 | 65 | 35 | 65 | 65 | 65 |
| Black S204 (3) | 65 | 40 | 65 | 65 | 65 | 65 |
| Additives (4) | 11 | 11 | 11 | 11 | 11 | 11 |
| Vulcanization system (5) | 8 | 9 | 9 | 9 | 8 | 12 |
| Of which insoluble sulfur | 4 | 4 | 4 | 4 | 4 | 4 |
| S/accelerator weight ratio | 1.21 | 0.80 | 0.80 | 0.80 | 0.95 | 0.50 |
| Properties in the cured state - | | | | | | |
| base 100 relative to C1 | | | | | | |
| Modulus at 6% (23° C.) (MPa) | 5.7 | 4.2 | 6.2 | 6.6 | 6.4 | 7.1 |
| G* 10% Deformation (40° C.) | 100 | 69 | 103 | 109 | 106 | 119 |
| Tan(δ) max (40° C.) | 100 | 38 | 127 | 95 | 89 | 94 |

The amounts are indicated in phr (parts by weight per hundred parts of elastomers).
(1) Natural rubber
(2) Functional polybutadiene “Nipol BR 1250H” sold by Zeon Corporation, Mooney plasticity of 50 MU
(3) Carbon black S204 from Orion Engineered Carbon, S_{BET} = 19 m²/g, COAN = 76 ml/100 g.
(4) The additives comprise zinc oxide (industrial grade, Umicore company), stearic acid (“Pristerene 4931” from Uniqema), N-1,3-dimethylbutyl-N-phenylparaphenylenediamine (“Santoflex 6-PPD” from Flexsys) and polymer 2,2,4-trimethyl-1,2-dihydroquinoline (TMQ)
(5) The vulcanization system comprises the insoluble sulfur, the accelerator (N, N-dicyclohexylbenzothiazole-2-sulfenamide from Flexsys) and the vulcanization retarder (N-cyclohexylthiophthalimide sold under the name “Vulkalent G” by Lanxess)

It is observed that the combination of the carbon black content, of the butadiene elastomer content and of the ratio of sulfur to accelerator is necessary for improving the stiffness/hysteresis compromise of the composition.

### Example 3

### Run-Flat Test

The tyres P1 and P2 are tyres of identical structure as shown in FIG. 1, comprising two sidewall inserts axially on the inside of the carcass reinforcement, the only difference being the composition of the sidewall inserts, as indicated in Table 3. The tyre P3 also comprises a side strip, the sidewall inserts, and also the bead-wire fillers, the side strips of each bead consisting of a composition according to the invention identical to that used for the sidewall inserts. For the tyre P1, the composition for sidewall insert corresponding to the composition M2 of document FR 3 005 471 (composition C1) is used.

The run-flat test is performed in accordance with UNECE Regulation 30 (reference E/ECE/324/Rev.1/Add.29/Rev.3). A value of 0 indicates that the tested tyre failed the run-flat test. A value of 1 indicates that the tested tyre successfully passed the run-flat test.

The weight of the two sidewall inserts axially inside the carcass reinforcement of the tyre is expressed in base 100 with reference to the weight of the two sidewall inserts axially inside the carcass reinforcement P1, a value greater than 100 attesting to a higher weight.

The rolling resistance is measured in accordance with UNECE Regulation 117 (reference E/ECE/324/Rev.2/Add.116/Rev.4). The rolling resistance is measured in a laboratory, at an ambient temperature of 25° C. To carry out this measurement, the laboratory uses a cylinder on which the tyre to be tested is applied, with a given load and pressure. The rolling resistance is expressed in base 100 with reference to the tyre P1. A value above 100 attests to a lower rolling resistance.

TABLE 3

| Tyre | P1 | P2 | P3 |
|---|---|---|---|
| Composition of the sidewall inserts | C1 | C8 | C8 |
| Run-flat test | 1 | 1 | 1 |
| Weight of sidewall inserts | 100 | 80 | 80 |
| Rolling resistance | 100 | 103 | 105 |

The results of Table 3 indicate that all the tyres tested provide the required EM performance (value 1 for the run-flat test). It is noted that the tyres in accordance with the invention have an improved weight and an improved rolling resistance.

1.-15. (canceled)

16. A rubber composition based on:
an elastomeric matrix comprising from 40 to 80 phr of at least one butadiene elastomer;
a vulcanization system comprising sulfur and a vulcanization accelerator, in which a weight ratio of sulfur to vulcanization accelerator is strictly less than 1; and
at least 55 phr of organic filler mainly comprising a carbon black having a BET specific surface area ranging from 15 to 50 m²/g and a compressed oil absorption number (COAN) ranging from 40 to 100 ml/100 g.

17. The rubber composition according to claim 16, wherein the at least one butadiene elastomer is selected from the group consisting of polybutadienes, butadiene copolymers and mixtures thereof.

18. The rubber composition according to claim 16, wherein the at least one butadiene elastomer has a Mooney plasticity of between 40 and 75 MU and a glass transition temperature of between −108 and −80° C.

19. The rubber composition according to claim 16, wherein the elastomeric matrix further comprises an isoprene elastomer.

20. The rubber composition according to claim 16, wherein the at least one butadiene elastomer is functionalized.

21. The rubber composition according to claim 20, wherein the functionalized butadiene elastomer comprises a functional group comprising a function selected from the group consisting of alkoxysilane, silanol, amine, carboxylic acid and polyether functions, and combinations thereof

22. The rubber composition according to claim 21, wherein the functionalized butadiene elastomer comprises a functional group comprising at least one amine function.

23. The rubber composition according to claim 16, wherein the rubber composition comprises from 20 to 60 phr of isoprene elastomer.

24. The rubber composition according to claim 16, wherein the rubber composition comprises from 55 to 80 phr of the carbon black.

25. The rubber composition according to claim 16 further comprising an inorganic filler selected from the group consisting of silica, alumina, chalk, clay, bentonite, talc, kaolin, glass microbeads, glass flakes, and mixtures thereof.

26. The rubber composition according to claim 25, wherein the inorganic filler is present in an amount from 3 to 30 phr.

27. The rubber composition according to claim 16, wherein the weight ratio of sulfur to vulcanization accelerator in the vulcanization system is less than or equal to 0.95.

28. A finished or semi-finished rubber article comprising the rubber composition according to claim 16.

29. A tire comprising the rubber composition according to claim 16.

30. A run-flat tire comprising a sidewall reinforcer comprising the rubber composition according to claim 16.
